(19) United States
(12) Patent Application Publication
(10) Pub. No.: US 2009/0070156 A1
(43) Pub. Date: Mar. 12, 2009

(54) Visitor parking system and method

(76) Inventor: Martin James Cleland-Pottie, Auckland (NZ)

Correspondence Address: JACOBSON HOLMAN PLLC, 400 SEVENTH STREET N.W., SUITE 600, WASHINGTON, DC, 20004, US

(21) Appl. No.: 12/213,829

(22) Filed: Jun. 25, 2008

(30) Foreign Application Priority Data
Jun. 25, 2007 (NZ) 556072

(51) Int. Cl. G07B 15/00; G06Q 30/00; G06Q 10/00; H04Q 5/22; G06Q 50/00

(52) U.S. Cl. 705/5; 705/13; 340/10.1

(57) ABSTRACT

A method of managing a visitor parking facility available to a plurality of users is described, the visitor parking facility comprising: a plurality of visitor parking bays, and a barrier for controlling the entry to and exit from the visitor parking facility of visitor vehicles. The method of managing the visitor parking facility available to a plurality of users comprising the steps of: registering a plurality of users, and storing user information; for each of the plurality of users limiting the number of visitor parking bays the user can book; receiving a request from a user to book a vehicle parking bay for a vehicle; booking a vehicle parking bay for the requesting user if the request is a valid request; storing the booking; and controlling the barrier to allow entry to and exit from the facility for a vehicle having a booked vehicle parking bay. The method also includes making statistical information on user usage of the visitor parking facility available. A system implement the method is also described.

### FIELD OF THE INVENTION

The present invention relates to the management of car parks and in particular but not exclusively to a system and method for managing a visitor parking facility in a building having multiple tenants.

### BACKGROUND OF THE INVENTION

Commercial buildings and in particular office blocks often include the provision of car parks for tenants and their visitors. One of the difficulties for tenants is that the number of car parks needed for visitors can vary. As a result tenants lease more car parks and in particular visitor car parks than they on average need resulting on under utilization of car parks.

A further issue is that governments and local authorities want to restrict the number of car parks provided in such buildings so as to reduce the number of commuters. In particular governments and local authorities want to restrict the number of commuters entering the central business district during peak traffic periods. However governments and local authorities want to allow car parking for those visitors who need car parks for short periods to conduct business during the business day.

One method used by some local authorities is to allow building owners to provide a fixed number of permanent car parks and a separate fixed number of temporary/casual car parks. A difficulty encountered is that it is difficult for local authorities to monitor the usage of temporary car parks and so local authorities are reluctant to grant permits for large numbers of visitor car parks in fear that over time the visitor car parks may end up used as permanent car parks.

It would be desirable to provide a system that would allow the sharing of the available visitor car parks in a building or buildings between tenants so that the available visitor car parks are used as efficiently as possible.

It would also be desirable to provide a means to charge for the shared parks in a way that affects the demand for those car parks and in a way that satisfies government usage conditions set on such car parks.

As used here ‘comprising’ or variations thereof means both or either consisting only of or including.

As used herein the term ‘and/or’ means ‘and’ or ‘or’, or both.

As used herein the term ‘(s)’ following a noun includes, as might be appropriate, the singular or plural forms of that noun.

The term ‘comprising’ as used herein means ‘consisting at least in part of, that is to say when interpreting independent paragraphs including that term, the features prefaced by that term in each paragraph will need to be present but other features can also be present.

### SUMMARY OF THE INVENTION

In a first embodiment the present invention consists in a method of managing a visitor parking facility available to a plurality of users, said visitor
parking facility comprising:
a plurality of visitor parking bays, and a barrier for controlling the entry to and exit from said visitor parking facility of visitor vehicles;
wherein said method of managing said visitor parking facility available to a plurality of users comprising the steps of:
registering a plurality of users, and storing user information;
for each of said plurality of users limiting the number of visitor parking bays said user can book;
receiving a request from a user to book a vehicle parking bay for a vehicle;
booking a vehicle parking bay for said requesting user if said request is a valid request;
storing said booking;
controlling said barrier to allow entry to and exit from said facility for a vehicle having a booked vehicle parking bay; and
providing statistical information on usage of said visitor parking facility to said users.

Preferably said step of booking a vehicle parking bay for said requesting user if said request is a valid request includes the steps of:
checking if said user has exceeded the user limit on the number of parking bays said user can book;
denying the booking request if said user has exceeded the limit; and
allowing the booking if said user has not exceed their limit.

Preferably said visitor parking facility is located in a commercial or office building having multiple tenants and each of said users is a tenant in said building.

Preferably including the steps of:
setting a charge for a period of use of a visitor parking bay; and
charging said user for each use of a visitor parking bay depending on the length of said use.

Preferably the step of setting a charge for each period of use of a visitor parking bay comprises setting a charge for different times to account for the likely demand for car parks at different times.

Preferably the maximum number of visitor parking bays each said user can book is set for each of said different time periods.

Preferably said visitor parking facility includes a data entry means associated with said barrier, and wherein the step of booking a vehicle parking bay includes the steps of:
issuing a security code to a user who successfully books a vehicle parking bay; and
storing said security code in association with said booking;
and wherein the step of controlling said barrier to allow entry to and exit from said facility for a vehicle having a booked vehicle parking bay includes the steps of:
receiving said security code via said data entry means;
checking if said received security code matches a stored security code; and
causing said barrier to open if said received security code matches a stored security code.

Preferably said data entry means is a keypad and said security code is a pin.

Preferably further comprising the steps of:
receiving vehicle characterization information from said user with said booking request;
storing said vehicle characterization information with said booking information;
means for capturing vehicle characterization information at said barrier;
comparing said stored vehicle characterization information and said captured vehicle characterization information; and
causing said barrier to open if said stored vehicle characterization information and said captured vehicle characterization information match.

Preferably said vehicle characterization information is a vehicle licence plate number.

Preferably said means for capturing said vehicle characterization information comprises camera means for photographing each vehicle license plate and processor means for processing the photograph of said license plate to obtain said vehicle license plate number.

Preferably said vehicle characterization information is an RFID tag identifier.

Preferably said statistical information on usage of said visitor parking facility to said users includes the average length of use of a vehicle bay by a visitor vehicle.

In a second embodiment the present invention may be said to consist in a visitor parking facility available to a plurality of users comprising:
a plurality of visitor parking bays, and
a barrier for controlling the entry to and exit from said visitor parking facility of visitor vehicles;
a system for managing said visitor parking facility comprising:
registration means for registering a plurality of users,
a data store for storing information on said plurality of users;
limit setting means for limiting the number of visitor parking bays said user can book for each of said plurality;
a booking interface for receiving a request from a booking request for a vehicle parking bay from a user,
validation means for validating said booking request;
booking storage means for storing a booking for a vehicle parking bay if said request is a valid request;
a barrier controller for controlling said barrier to allow entry to and exit from said facility for a vehicle having a booked vehicle parking bay;
a usage calculator for calculating statistical information on usage of said visitor parking facility by said users; and
reporting means for making said statistical information available to said users.

Preferably said validation means includes means for:
checking if said user has exceeded the user limit on the number of parking bays said user can book;
denying the booking request if said user has exceeded the limit; and
allowing the booking if said user has not exceed their limit.

Preferably said visitor parking facility is located in a commercial or office building having multiple tenants and each of said users is a tenant in said building.

Preferably including means for:
setting a charge for a period of use of a visitor parking bay; and
charging said user for each use of a visitor parking bay depending on the length of said use.

Preferably the means for setting a charge for a period of use of a visitor parking bay includes means for setting a charge for different times to account for the likely demand for car parks at different times.

Preferably the maximum number of visitor parking bays each said user can book is set for each of said different time periods.

Preferably said visitor parking facility includes a data entry means associated with said barrier, and wherein said booking interface includes:
means for issuing a security code to a user who successfully books a vehicle parking bay; and
means for storing said security code in association with said booking;
and wherein said barrier controller receives said security code via said data entry means and checks if said received security code matches a stored security code; and said barrier controller causes said barrier to open if said received security code matches a stored security code.

Preferably said data entry means is a keypad and said security code is a pin.

Preferably said booking interface includes:
means for receiving vehicle characterization information from said user with said booking request;
means for storing said vehicle characterization information with said booking information;
means for capturing vehicle characterization information at said barrier; and
means for comparing said stored vehicle characterization information and said captured vehicle characterization information;
wherein said barrier controller causes said barrier to open if said stored vehicle characterization information and said captured vehicle characterization information match.

Preferably said vehicle characterization information is a vehicle license plate number.

Preferably said means for capturing said vehicle characterization information comprises a camera for photographing each vehicle license plate and a processor for processing the photograph of said license plate to obtain said vehicle license plate number.

Preferably said vehicle characterization information is an RFID tag identifier.

Preferably said statistical information on usage of said visitor parking facility to said users includes the average length of use of a vehicle bay by a visitor vehicle.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

FIG. 1 is a schematic diagram of a car park and system of the present invention,

FIG. 2 is a screenshot of the site interface of the present invention,

FIG. 3 is a table containing the site information of a site of the present invention,

FIG. 4 is a screenshot of a rate period interface of the present invention,

FIG. 5 is a screenshot of a tenant list interface of the present invention,

FIG. 6 is a screenshot of the new tenant creation interface of the present invention,

FIG. 7 is a screenshot of the booking interface of the present invention,

FIG. 8 is a screenshot of the booking availability interface of the present invention, and

FIG. 9 is a screenshot of a statistics interface of the present invention,

These and other aspects of this invention, which would be considered as novel in all aspects would become apparent from the following description, which is given by way of example only, with reference to the accompanying drawings in which:

### DETAILED DESCRIPTION OF THE DISCLOSED EMBODIMENTS

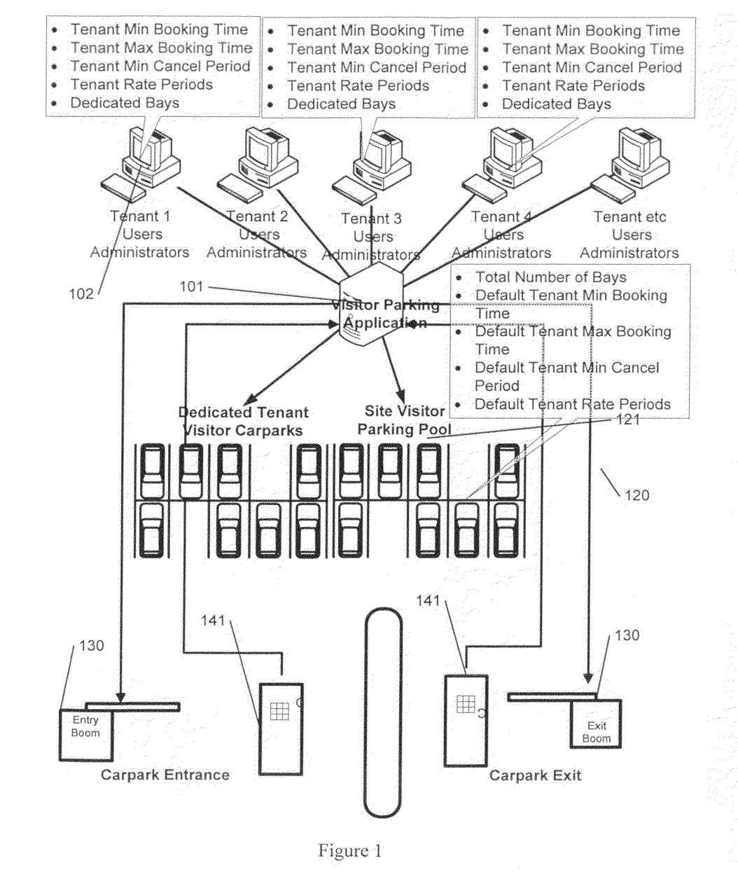

Referring to FIG. 1 the present invention will be described. The present invention operates in client server mode. In the preferred embodiment the server 101 hosts a database for storing information on the system and a web application that is accessed by the various clients 102 of the system. Clients 102 can access the system using various internet browsers including Firefox and Internet Explorer. The various users of the system including the system administrator could also assess the system via a web application. While the system has been described with reference to one server 101, if the load was sufficient multiple servers could be used as known in the art, to balance the workloads.

Each cark parking site 120 is controlled by a user or users with appropriate security settings. This may be a site manager or the system administrator. A single system could be used for multiple site managers and each site manager(s) could control multiple sites. A system administrator would set up the site managers within the system.

Each site manager would be able to set up and administer a number of sites, subject to agreed license conditions with the system operator.

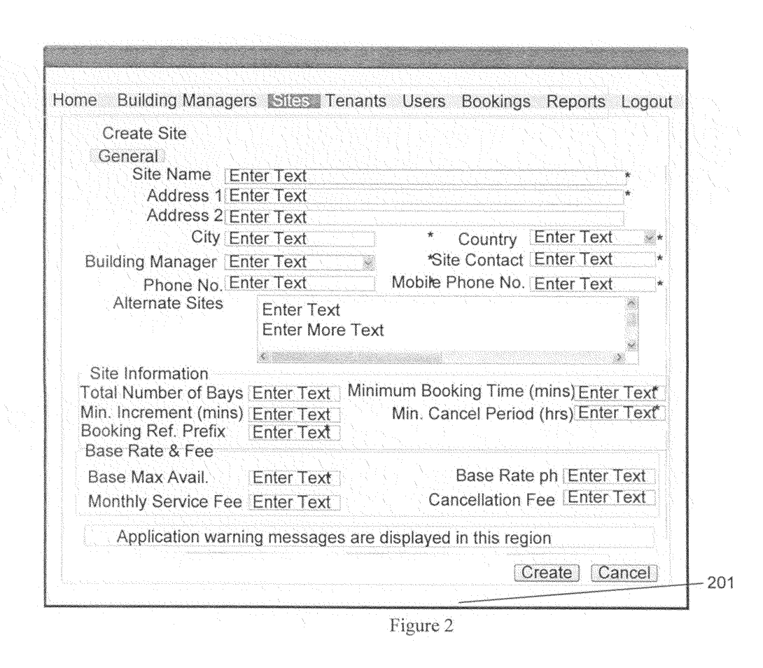

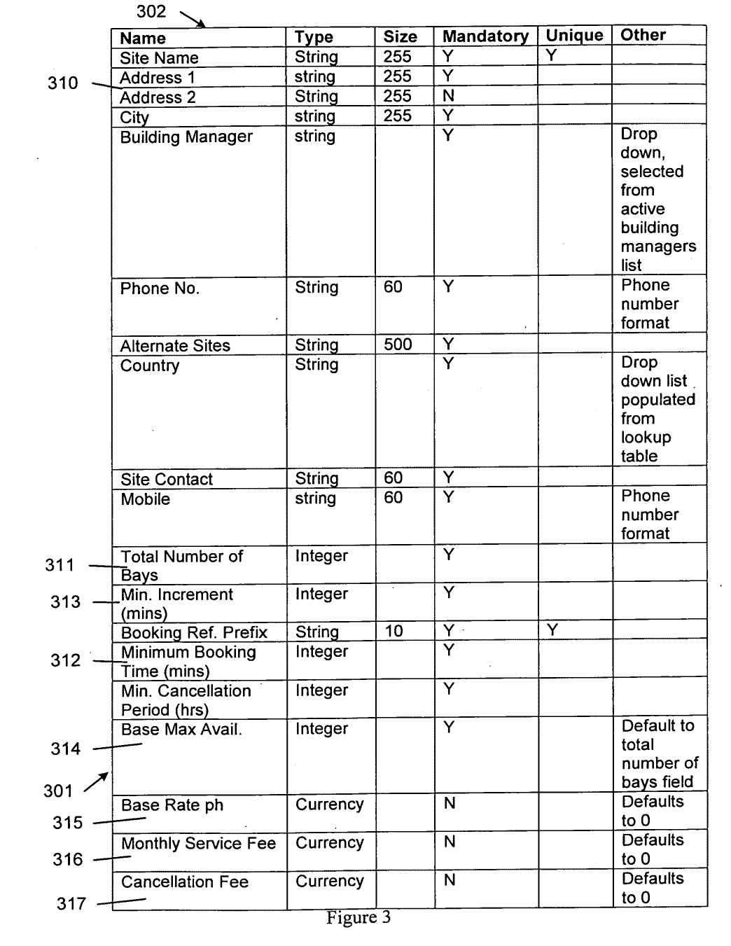

A visitor parking facility 121 at a site 120 is the key component of the system. For each visitor parking facility the building manager enters various site parameters as seen in FIG. 2 which is an illustration of the site creation management screen 201 of the system client interface page. Once the information 302 is entered, the information is stored in a database table 301 illustrated in FIG. 3.

The information 302 stored includes the site address 310, the total number of visitor parking bays 311, the default units 312 for incrementing a booking time, the minimum booking time 313, the number of car parks available 314, the base charge rate 315, the monthly service fee 316, and the cancellation fee 317. A similar screen is available for editing each site.

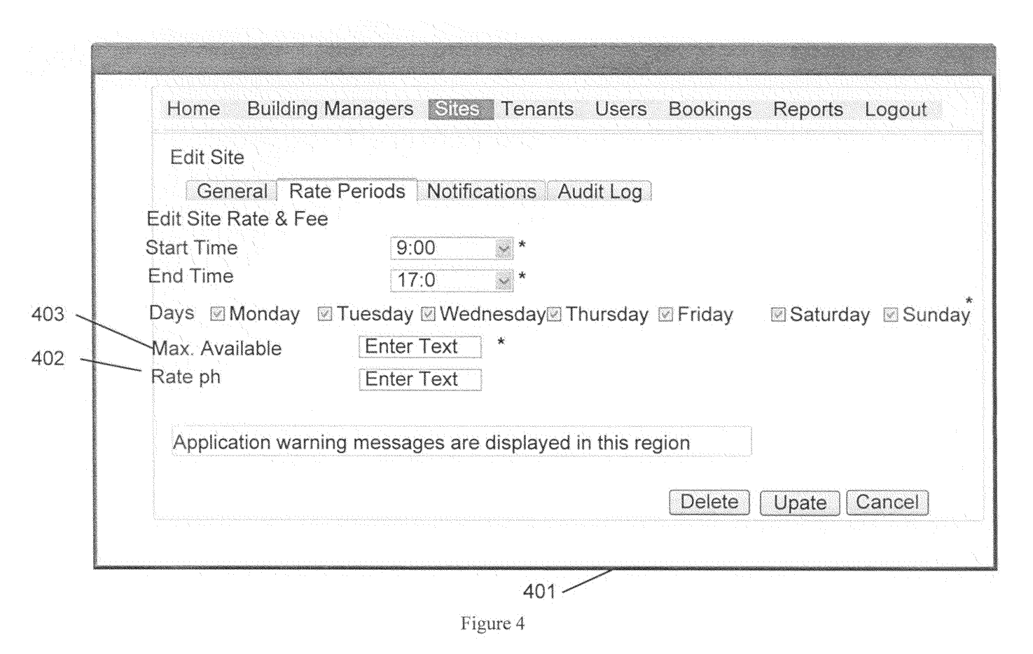

At each visitor parking facility a user with appropriate permissions such as a site manager or site administrator can set various charges including the rate for at least one period. FIG. 4 illustrates setting the charge out rate input screen 401. The site administrator can set rates 402 for different time periods and the maximum number of bays 403 to account for the fact that the demand for car parks is likely to be less at night or weekends. In a similar manner a more expensive rate can be set for Friday to account for the fact that more car parks are used on Fridays than on other days. A similar interface is used to edit the rate periods.

The system has the ability to notify car park users who have made a booking by email. While only an email notification system is described other notification systems including automated telephone calls or text messaging could also be utilized. The system envisages a user being emailed to confirm a booking, to confirm a cancellation, on the creation of a new user and when a password is reset. An email may also be sent in the case of a booking overrun were a bay is still in use after end of the booked period.

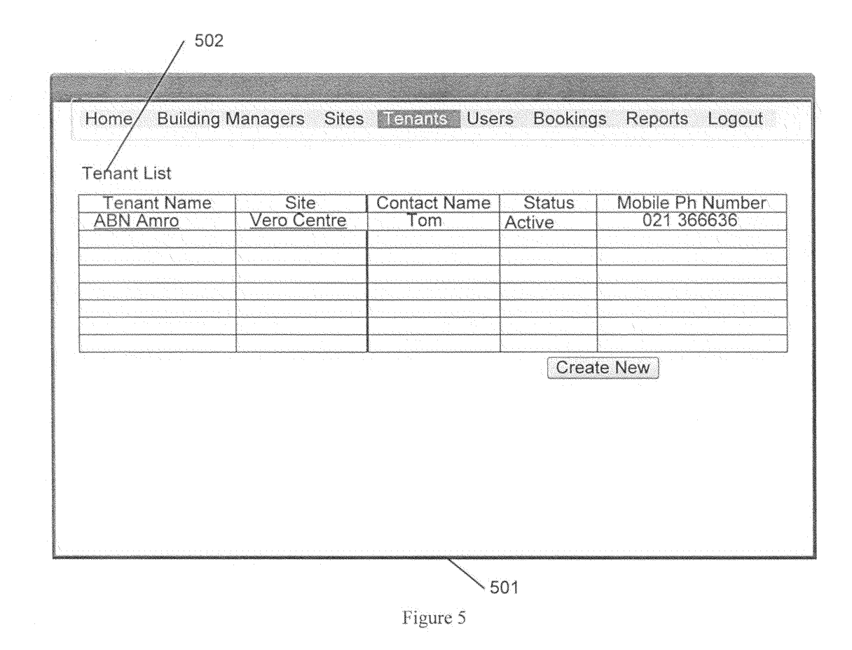

Each site manager is able to set up a list of tenants for the sites that they manage. Referring to FIG. 5 the list of current tenants 502 interface 501 is illustrated.

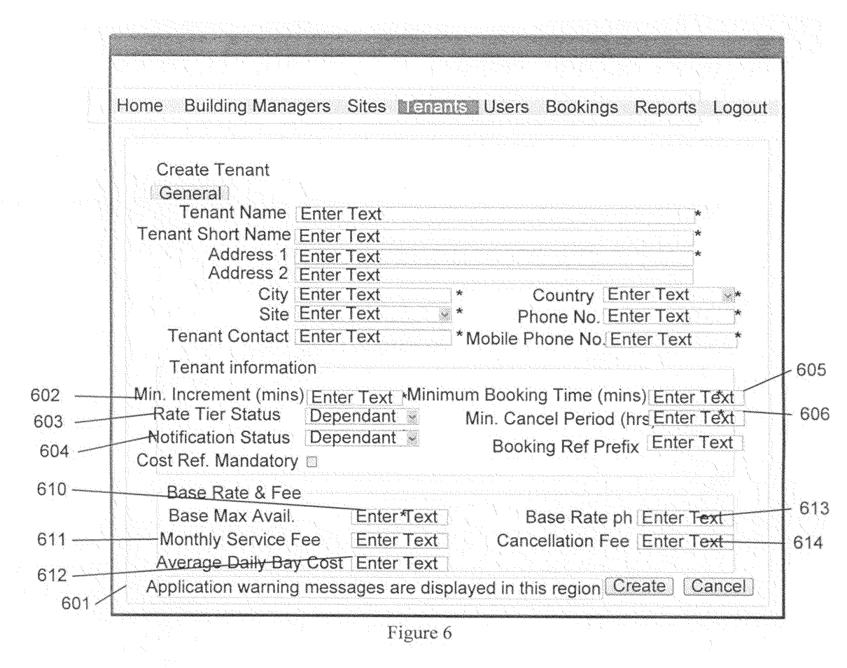

Subject to appropriate system permissions a site manager may add new tenants and to edit the details of existing tenants. FIG. 6 illustrates the site manager interface 601 for adding a new tenant. Various details including name, address and tenant contact are required.

Importantly in terms of managing access to the car parks this tenant input/edit interface 601 allows the site administrator to set various setting. Including minimum increment in parking time (minutes) 602, rate tier status 603, notification status 604, minimum booking time 605, and minimum cancellation time 606. In terms of charges the site administrator can set the maximum number of car parks available to each tenant 610, the monthly service fee 611, the average daily bay cost 612, the base rate per hour 613 and the cancellation fee 614.

Setting the maximum number of car parks available to a particular tenant allows the administrator to control car park access so that smaller tenants do not book all the cars parks.

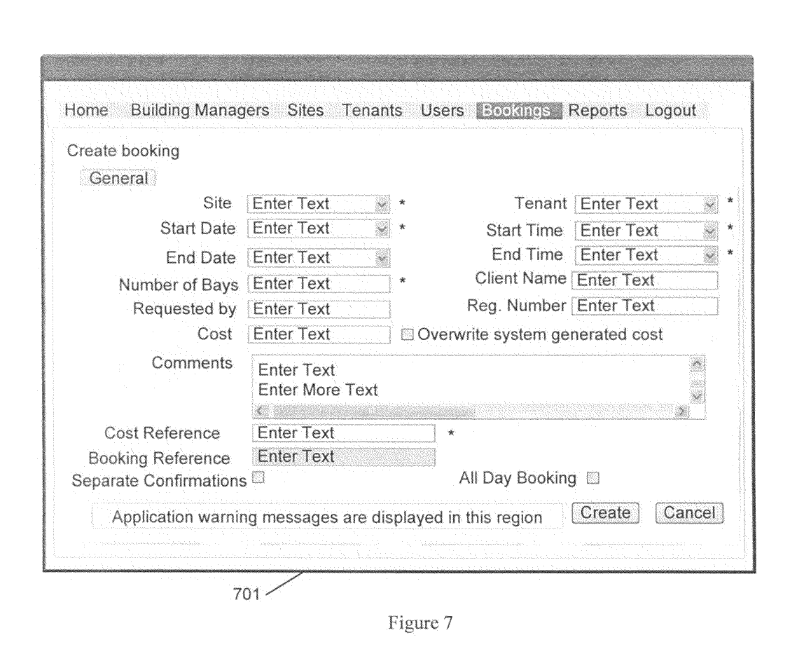

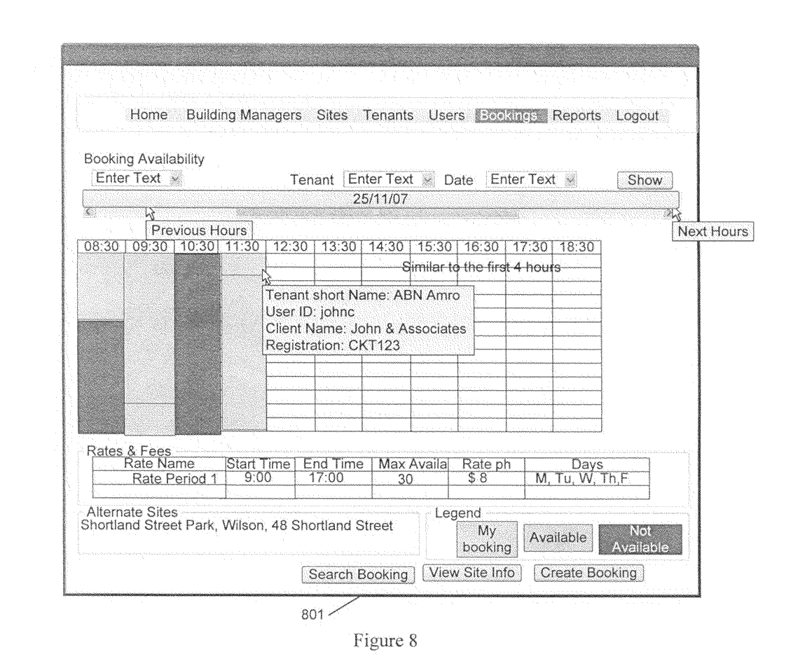

Referring again to FIG. 1 entry and exit to the car park can be controlled by various means. For example when a booking is made using the booking interface 701 seen in FIG. 7 the user making the booking may be emailed an entry code for the gate. To make a booking a user can check booking availability using an interface 801 such as seen in FIG. 8.

The gates 130 would be connected to the system and allow the use of the entry code, via entry into a keypad, for a predetermined period before the booking commences. To exit the car park the user would need to enter the same entry code. Charges would be based on the maximum of the booking period or the length of stay. In one embodiment the code would no longer be usable a number of minutes after the end of the pre-booked period.

Alternatively a vehicle registration sensing system could detect the registration number of the vehicle associated with a booking and the entry and exit times recorded based on the registration number. Vehicle identification could be carried out using a camera or multiple cameras and computer means to identify the vehicle registration or other characteristics.

An alternative system could for example use a radio frequency identifier (“RFID”) in a vehicle and a sensor connected to the server of the present invention to identify when a vehicle is at or near a barrier. Such an RFID could be embedded within the registration label or card on the windscreen of the vehicle.

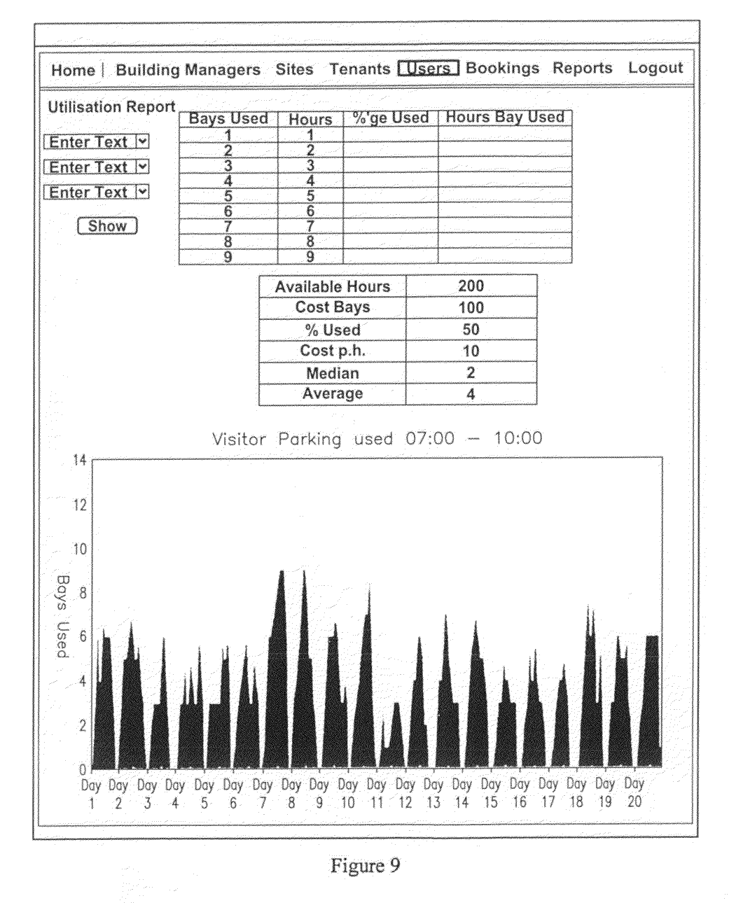

As well as allowing for bookings, the system of the present invention can provide the various system users with usage summaries as seen in FIG. 9. So for example a tenant could analyze their usage for a given period. This would allow the tenant to access whether they need to increase or decease the maximum number of car parks that they can book. Subject of course to the requirements of the other tenants in the building.

Further local authorities could be given access to the system to allow them to monitor usage of the car parks. While not illustrated the present invention will allow an administrator to set maximum booking time limits on car parks so that temporary car parks are not used as permanent car parks. Local authorities can then access booking statistics including for example average booking time.

In an alternative embodiment the system charges could be altered so that longer booking are charged more per hour than shorter booking. For example if the local authority sets the average maximum booking to be less than two and a half hours. Then the tenants could be charged $x for the first 2 hours 2 time $x for the next two hours and 4 times $x for any hours after this period. Such a system would discourage longer bookings.

In another alternative embodiment, service personnel would have specific booking codes to allow the parking of service vehicles for longer periods of time.

In a further embodiment the site administrator will set a guaranteed number of car parks that are available for each tenants use and the maximum number of car parks that a tenant can book.

TABLE 1

| | Minimum | Maximum allowed |
|---|---|---|
| Tenant A | 8 | 16 |
| Tenant B | 8 | 16 |
| Tenant C | 4 | 8 |

For example in Table 1 if we assume there are 30 visitor car parks. Tenant A is guaranteed to always have 8 available for their use but can book up to 16 car parks. Tenant B is guaranteed to always have 8 available for their use but can book up to 16 car parks. Tenant C is guaranteed to always have 4 available for their use but can book up to 8 car parks.

To further explain, suppose tenant A has 6 car parks booked, tenant B has 14 car parks booked and tenant C has 8 car parks booked. When tenant B attempts to book a further car park the system will reject the booking. This will occur because the system knows that there are only 30 car parks, it knows that 28 are booked, the system further knows that 8 car parks are reserved for tenant A and tenant A has only booked 6 parks so the system must reserve the 2 remaining parks for tenant A to book.

While it has been assumed that the number of car parks reserved is fixed an alternative embodiment of the system could see that the number of reserved parks alters depending on the time of day. So for example the following table might apply between 10 pm and 6 am Monday to Friday and between 10 pm on Friday and 6 am Monday.

TABLE 2

| | Minimum | Maximum allowed |
|---|---|---|
| Tenant A | 0 | 30 |
| Tenant B | 0 | 30 |
| Tenant C | 0 | 30 |

In a further embodiment of the system tenants could alter their own minimum reserved car parks to any number as long as the number is at or below the level set by the site administrator. When the system makes a decision as to whether or not to allow a booking the system will ensure that the minimum reserved car parks are available for each tenant.

The system of the current invention allows the sharing of visitor car parks in a multi-tenanted building allowing tenants to minimize their overall cost while providing for the maximum number of needed car parks. The system further allows for regulators to control and monitor the use of visitor car parks.

As part of the monitoring process fines could be imposed by regulators if visitor car parks are used as permanent car parks.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A method of managing a visitor parking facility available to a plurality of users, said visitor parking facility comprising:
a plurality of visitor parking bays, and
a barrier for controlling the entry to and exit from said visitor parking facility of visitor vehicles;
wherein said method of managing said visitor parking facility available to a plurality of users comprising the steps of:
registering a plurality of users, and storing user information;
for each of said plurality of users limiting the number of visitor parking bays said user can book;
receiving a request from a user to book a vehicle parking bay for a vehicle;
booking a vehicle parking bay for said requesting user if said request is a valid request;
storing said booking;
controlling said barrier to allow entry to and exit from said facility for a vehicle having a booked vehicle parking bay; and
providing statistical information on usage of said visitor parking facility to said users.

2. The method according to claim 1, wherein said step of booking a vehicle parking bay for said requesting user if said request is a valid request includes the steps of:
checking if said user has exceeded the user limit on the number of parking bays said user can book;
denying the booking request if said user has exceeded the limit; and
allowing the booking if said user has not exceed their limit.

3. The method according to claim 2, wherein said visitor parking facility is located in a commercial or office building having multiple tenants and each of said users is a tenant in said building.

4. The method according to claim 3, including the steps of:
setting a charge for a period of use of a visitor parking bay; and
charging said user for each use of a visitor parking bay depending on the length of said use.

5. The method according to claim 4, wherein the step of setting a charge for each period of use of a visitor parking bay comprises setting a charge for different times to account for the likely demand for car parks at different times.

6. The method according to claim 5, wherein the maximum number of visitor parking bays each said user can book is set for each of said different time periods.

7. The method according to claim 6, wherein said visitor parking facility includes a data entry means associated with said barrier, and wherein the step of booking a vehicle parking bay includes the steps of:
issuing a security code to a user who successfully books a vehicle parking bay; and
storing said security code in association with said booking; and wherein the step of controlling said barrier to allow entry to and exit from said facility for a vehicle having a booked vehicle parking bay includes the steps of:
receiving said security code via said data entry means;
checking if said received security code matches a stored security code; and
causing said barrier to open if said received security code matches a stored security code.

8. The method according to claim 7, wherein said data entry means is a keypad and said security code is a pin.

9. The method according to claim 6, further comprising the steps of:
receiving vehicle characterization information from said user with said booking request;
storing said vehicle characterization information with said booking information;
means for capturing vehicle characterization information at said barrier;
comparing said stored vehicle characterization information and said captured vehicle characterization information; and
causing said barrier to open if said stored vehicle characterization information and said captured vehicle characterization information match.

10. The method according to claim 9, wherein said vehicle characterization information is a vehicle license plate number.

11. The method according to claim 10, wherein said means for capturing said vehicle characterization information comprises camera means for photographing each vehicle license plate and processor means for processing the photograph of said license plate to obtain said vehicle license plate number.

12. The method according to claim 9, wherein said vehicle characterization information is an RFID tag identifier.

13. Computer software implementing the method of claim 1.

14. A visitor parking facility available to a plurality of users comprising:
a plurality of visitor parking bays, and
a barrier for controlling the entry to and exit from said visitor parking facility of visitor vehicles;
a system for managing said visitor parking facility comprising:
registration means for registering a plurality of users,
a data store for storing information on said plurality of users;
limit setting means for limiting the number of visitor parking bays said user can book for each of said plurality;
a booking interface for receiving a request from a booking request for a vehicle parking bay from a user,
validation means for validating said booking request;
booking storage means for storing a booking for a vehicle parking bay if said request is a valid request;
a barrier controller for controlling said barrier to allow entry to and exit from said facility for a vehicle having a booked vehicle parking bay;
a usage calculator for calculating statistical information on usage of said visitor parking facility by said users; and
reporting means for making said statistical information available to said users.

15. The visitor parking facility according to claim 14, wherein said validation means includes means for:
checking if said user has exceeded the user limit on the number of parking bays said user can book;
denying the booking request if said user has exceeded the limit; and
allowing the booking if said user has not exceed their limit.

16. The visitor parking facility according to claim 15, wherein said visitor parking facility is located in a commercial or office building having multiple tenants and each of said users is a tenant in said building.

17. The visitor parking facility according to claim 16, including means for:
setting a charge for a period of use of a visitor parking bay; and
charging said user for each use of a visitor parking bay depending on the length of said use.

18. The visitor parking facility according to claim 17, wherein the means for setting a charge for a period of use of a visitor parking bay includes means for setting a charge for different times to account for the likely demand for car parks at different times.

19. The visitor parking facility according to claim 18, wherein the maximum number of visitor parking bays each said user can book is set for each of said different time periods.

20. The visitor parking facility according to claim 19, wherein said visitor parking facility includes a data entry means associated with said barrier, and wherein said booking interface includes:
means for issuing a security code to a user who successfully books a vehicle parking bay; and
means for storing said security code in association with said booking; and wherein said barrier controller receives said security code via said data entry means and checks if said received security code matches a stored security code; and said barrier controller causes said barrier to open if said received security code matches a stored security code.

21. The visitor parking facility according to claim 20, wherein said data entry means is a keypad and said security code is a pin.

22. The visitor parking facility according to claim 19, wherein said booking interface includes:
means for receiving vehicle characterization information from said user with said booking request;
means for storing said vehicle characterization information with said booking information;
means for capturing vehicle characterization information at said barrier; and
means for comparing said stored vehicle characterization information and said captured vehicle characterization information;
wherein said barrier controller causes said barrier to open if said stored vehicle characterization information and said captured vehicle characterization information match.

23. The visitor parking facility according to claim 22, wherein said vehicle characterization information is a vehicle license plate number.

24. The visitor parking facility according to claim 23, wherein said means for capturing said vehicle characterization information comprises a camera for photographing each vehicle license plate and a processor for processing the photograph of said license plate to obtain said vehicle license plate number.

25. The visitor parking facility according to claim 22, wherein said vehicle characterization information is an RFID tag identifier.
